(19) United States
(12) Patent Application Publication
(10) Pub. No.: US 2009/0199104 A1
(43) Pub. Date: Aug. 6, 2009

(54) IDEA COLLABORATION METHOD

(75) Inventors: Paul Pluschkell, JR., Pleasanton, CA (US); Padmanabh Dinkar Dabke, Danville, CA (US)

Correspondence Address: PEPPER HAMILTON LLP, ONE MELLON CENTER, 50TH FLOOR, 500 GRANT STREET, PITTSBURGH, PA, 15219, US

(73) Assignee: SPIGIT, INC., Pleasanton, CA (US)

(21) Appl. No.: 12/364,331

(22) Filed: Feb. 2, 2009

Related U.S. Application Data
(60) Provisional application No. 61/025,550, filed on Feb. 1, 2008.

(51) Int. Cl. G06F 3/048; G06Q 30/00

(52) U.S. Cl. 715/733; 705/14

(57) ABSTRACT

A method of ranking user reputation in a multi-user network includes using a display interface to display various concepts for discussion to multiple users of the network. The method includes receiving, from a first registered user via a data interface, a discussion post and a ranking for one of the displayed concepts. Other registered users submit responses to the first registered user's discussion post, such that each response includes an indication of whether the response is positive or negative. The method includes determining, via a processing device, a reputation rank for the first registered user. The reputation rank calculation is based on a number of discussion posts received from that registered user, as well as a number of positive responses received from the other registered users for the first registered user's discussion posts. The method includes displaying the reputation rank to the registered users via the display interface.

### CROSS REFERENCE TO RELATED APPLICATIONS

This patent application claims priority to U.S. Provisional Patent Application No. 61/025,550, filed Feb. 1, 2008. This application is related to co-pending U.S. patent application Ser. No. 12/364,291, filed Feb. 2, 2009.

### BACKGROUND

In today's economy, innovation is essential to the long-term success of an organization. In many organizations, new products, services, marketing initiatives, supporting tools, and other ideas arise on a frequent basis. However, the tools that allow organizations to share, collaborate on, improve, evaluate, filter and rank new ideas are very limited.

This disclosure describes a method and system that is directed to solving one or more of the problems described above.

### SUMMARY

In an embodiment, a method of ranking user reputation in a multi-user network includes using a display interface to display various concepts for discussion to multiple users of the network. The method includes receiving, from a first registered user via a data interface, a discussion post and a ranking for one of the displayed concepts. Other registered users submit responses to the first registered user's discussion post, such that each response includes an indication of whether the response is positive or negative. The method includes determining, via a processing device, a reputation rank for the first registered user. The reputation rank calculation is based on a number of discussion posts received from that registered user, as well as a number of positive responses received from the other registered users for the first registered user's discussion posts. The method includes displaying the reputation rank to the registered users via the display interface.

Optionally, the method also may include determining an indication of merit for the selected displayed concept. The indication of merit may be based at least in part on the reputation rank for each user who submitted a discussion post or ranking for the selected displayed concept. Also, the indication of merit may be based on at least a number of different registered users who have submitted comments for the selected displayed concept; a user interest for the selected displayed concept.

Optionally, determining the reputation rank for the first registered user may be based on a number of positive rankings that have been received from other registered users for ideas previously submitted by the first registered user; and a number of negative rankings that have been received from other registered users for ideas previously submitted by the first registered user. The reputation rank for the first registered user also may be based on a number of friends that have connected to the first registered user as connected friends, a number of positive rankings that the connected friends have submitted for the first registered user, and/or a number of negative rankings that the connected friends have submitted for the first registered user. Also, the reputation rank for the first registered user may be based on a number of ideas posted by the first registered user that have a successful exit, and/or a number of ideas posted by the first registered user that have an unsuccessful exit. Also, the reputation rank for the first registered user may be based on an amount of virtual money that the first registered user has invested in correct outcomes in a prediction market, and/or an amount of virtual money that the first registered user has invested in incorrect outcomes in the prediction market.

In some embodiments, the method also may include receiving a first discussion concept from the first registered user, as well as receiving comments to the first discussion concept from other registered users. Each comment may include an indication of whether it is positive or negative. The method may include determining, via the processing device, an indication of merit from the first discussion concept. The method also may include providing a reward to the first registered user, wherein the amount of the reward is based on the indication of merit for the first discussion concept and the reputation rank for the first registered user.

Any or all of the above-described actions may be embodied in a computer-program product containing computer-readable code that instructs a computing device to perform a method of ranking user reputation in a multi-user network.

### BRIEF DESCRIPTION OF THE DRAWINGS

FIG. 1 illustrates an exemplary graphic user interface for an idea collaboration system.

FIG. 2 depicts an exemplary process of assessing the merit of various ideas.

FIG. 3 depicts an exemplary process of ranking the reputation of individual users of an idea collaboration system.

FIG. 4 is a block diagram of an exemplary system that may be used to contain or implement program instructions according to an embodiment

### DETAILED DESCRIPTION

Before the present methods and systems are described, it is to be understood that this disclosure is not limited to the particular methodologies and systems described, as these may vary. It is also to be understood that the terminology used in the description is for the purpose of describing the particular versions or embodiments only, and is not intended to limit the scope. For example, as used herein and in the appended claims, the singular forms “a,” “an,” and “the” include plural references unless the context clearly dictates otherwise. In addition, the word “comprising” as used herein is intended to mean “including but not limited to.” Unless defined otherwise, all technical and scientific terms used herein have the same meanings as commonly understood by one of ordinary skill in the art.

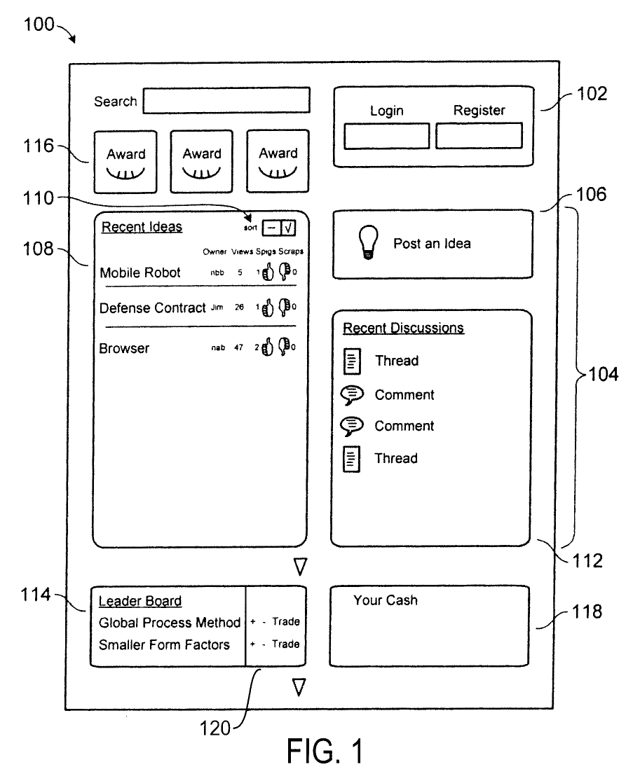

Referring to FIG. 1, elements of an idea collaboration system 100 are shown as accessed by a graphic user interface, such as a browser-based display that may be accessed via the Internet, an intranet or another communications network. The system 100 may be made accessible via networked computers, personal digital assistants, mobile electronic devices, and/or other electronic communication devices to individuals who are participants in an enterprise, such as a corporation, non-profit entity, university, research collaborative, trade organization, or other group. In some embodiments, access to some or all of the system may be limited to users who have registered with the system. This may help to limit access to employees, organization members, or other specified individuals. The system may include a user login interface 102, such as a username/password input field, a biometric input, or another electronic interface to limit access to users who have registered with, or granted access by, the system.

The system may include an Innovation Market 104, which is a portion 106 of an electronic user input interface that allow users to input ideas, and a display interface 108 that displays some or all the submitted ideas. Optionally, the hub 104 may include a display selector 110, which is an electronic user interface that allows a user to select how the ideas will be displayed, with options such as most recent, most popular, display by category, or display all.

The system may also include a Prediction Market 120, which is a portion of an electronic user input interface that offers shares (i.e., virtual ownership interests) in mutually exclusive set of outcomes, exactly one of which is determined to be true at a specified or yet-to-be-determined time in future. Users can use rewards, points, tokens or other virtual currency to purchase shares in one or more predicted outcomes. The share price is determined by any suitable method, such as the ratio of outstanding shares in the outcome to total number of outstanding shares and reputation level of users. When an outcome is determined to be true, all users who purchased shares of that outcome receive a virtual currency amount per share purchased that is equal to the maximum possible share price.

The Innovation Market 104 or another portion of the system also may include a discussion section 112, which is an electronic user interface that allows users to submit comments on and rankings for ideas, respond to other comments and rankings, and create discussion threads about ideas. The system also may include one or more an indication of merit sections 114, 116, each of which is a display that graphically or descriptively provides an indication of a merit ranking for submitted ideas. For example a merit section 116 may display “awardees”, or ideas which have achieved a highest ranking in one or more categories. Alternatively, a “leading ideas” section 114 may list any number of ideas having merit ranks that are higher than others, or merit ranks that exceed a user-selected or predetermined threshold. The display interface 108 also may include a merit indicator that allows a user to use the display selector 110 to selectively show the most popular ideas, most discussed ideas, a list of ideas having the highest number of user positive rankings, or another user-selected category. The system also may include a rewards section 118, which is a display that allows the user to see and use rewards, compensation or other items of value that the user has received from the system.

In an embodiment, the merit ranking of an idea may be indicated by a number that lies within a preset scale. In an embodiment, users can use their virtual currency in purchasing shares in any of the ideas presented to the system. The cost of a single share in the idea may be equal to, based on or otherwise related to the merit ranking of the idea at the time of purchase. Each idea has a finite life span and can have either a successful exit or an unsuccessful exit. Upon successful exit, each share purchased in the idea may pay back virtual currency equal to the maximum possible value of the merit index, or some other appropriate value.

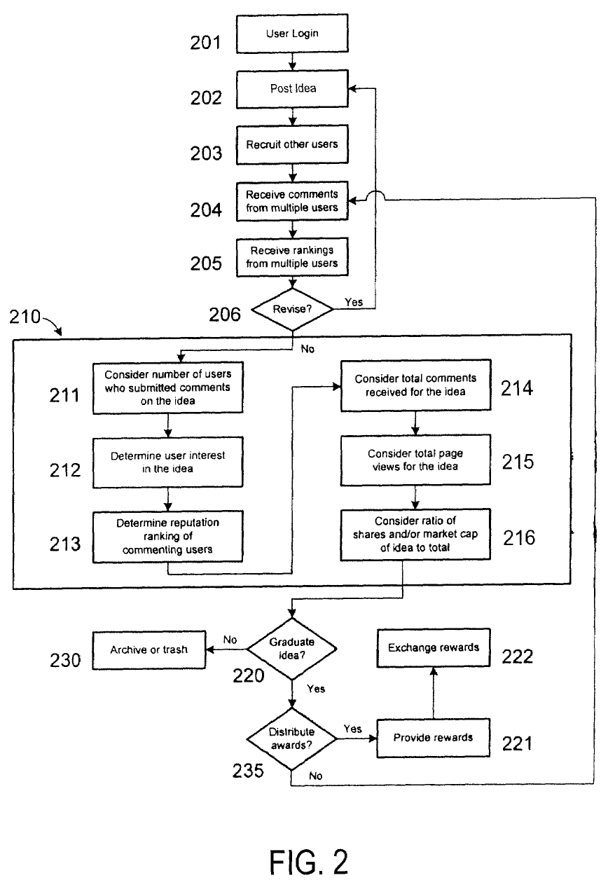

FIG. 2. illustrates an exemplary automated merit ranking process. A user may access 201 the system by logging in with a username and password, by a biometric entry (such as a fingerprint scan), or by some other means that authenticates the user to the system. In a captive computer network where the user has already been authenticated in order to access the network, a separate user login may or may not be needed for the user to access the idea collaboration system. The login also may allow a user to create and/or edit a stored user profile. The user profile may contain items such as a biography, work history, or other resume information; “connections” who are other users that agreed to be identified as connected to this user; links to the user's idea posts, comments, threads, reviews, blog entries or other information; rankings of the user or the user's ideas; recent activity, and rewards portfolio. Some or all of this information may be made available for other users to view. In some embodiments, the viewing of some or all of the information may be limited to individuals who are connected to this user.

In addition, during the registration process users may be required to accept a confidentiality agreement to ensure that ideas shared on the system are not disclosed outside of the enterprise for which the collaboration system is deployed.

A user may post an idea 202 by entering information describing the idea into the system. This may be done by filling out a fact sheet or other form with predetermined fields. At least one of the fields may permit the user to provide a free-form description of the idea. In addition, the user may be permitted to post one or more electronic files, such as articles, presentations, graphics, or videos, and associate the electronic files with the idea. The collaboration system receives an idea from the user and stores it in a computer-readable memory so that it can be displayed to other authorized users for review and comment. The idea may then be made available to other users on the system for review and comment.

Optionally the user who submitted the idea may recruit 203 other users to comment on the idea by identifying those other users so that the other users receive a message inviting them to view the idea.

Users may post comments 204 on the idea, such as reviews, questions, or suggestions for improving the idea. A comment may be positive or negative, so that the users also post a ranking 205 of the idea, such as “thumbs up/thumbs down”, a numeric ranking on a scale, a letter grade, or some other rank which indicates the user's impression of the idea. Other users may post responses to comments or rankings, thus creating a discussion thread about the idea. Optionally, users may be permitted to revise 206 a comment, ranking or idea after having the opportunity to see subsequent comments and rankings. In such a case, any or all of the previous steps may be repeated. Optionally, users may be limited in the number of rankings they can provide for an idea, although they may be permitted to purchase additional rankings by trading rewards, as described below.

The system determines a merit ranking 210 for the idea by considering factors such as any or all of the following: the total number of different users who submitted comments on the idea 211, user interest in the idea (such as by a measurement of the positive and/or negative comments or rankings received for the idea) 212, a reputation ranking of users who submitted comments and/or rankings 213, the total number of comments (optionally including discussion posts and rankings) for the idea 214, a total number of views (such as page views) of the idea 215, and a ratio 216 of outstanding shares and/or market capitalization of the idea to the total outstanding shares and/or total market capitalization of all ideas. Any of the factors listed above may be listed equally to or different from other factors. For example, in an embodiment greater weight may be given to negative comments than to positive comments, so that negative comments are more likely to affect the overall merit ranking than positive comments.

Based on the merit ranking, the user who submitted the idea may receive a reward 221, such as public recognition in a category, or an award that can be redeemed or exchanged 222 for other things in the system, including the ability to buy credits that allow the user to rank other ideas. Optionally, users may exchange 222 rewards between themselves, and an idea submitter may offer rewards to other users who help build popularity for the idea. Optionally, the determination of an award 222 may also be based on factors such as the user's individual reputation ranking. For example the merit rank may be multiplied by the reputation rank to determine an award. The award determination also may be based on factors such as the number of ideas posted by a user, the number of comments that the user has posted for third party ideas, and other factors.

Optionally, before awards are distributed, an idea may be required to be filtered through one or more merit levels. After receiving comments and determining a ranking, and after a predetermined threshold (such as a time period or a number of received comments), the system may determine whether the idea should graduate to the next merit level 220. For example, if an idea receives less than a required number of positive comments during a time period, or if it receives more than a threshold number of negative comments during the time period, the idea may be archived or trashed 230 so that it is either removed from further public review or placed in a less prominent area of the system. If the idea does graduate to the next level, then the system determines whether to distribute rewards 235 and/or seek further public comment on the idea.

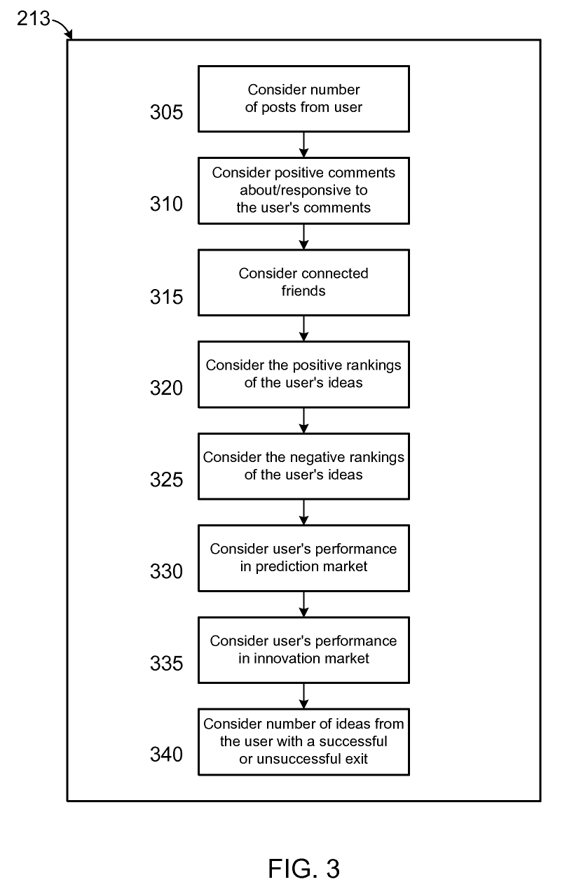

FIG. 3 provides additional detail about how a reputation ranking of a user may be determined (step 213 from FIG. 2). Referring to FIG. 3, a user's reputation ranking may be based on a mathematical calculation that considers factors such as any or all of the following: the number of posts (comments, rankings, ideas, etc.) that the user has submitted 305; the number of positive (or negative) comments 310 that have been received about or in response to the user's comments; the number of other users who have agreed to be connected to this user 315; the number of positive rankings that the user has received for his or her own ideas, comments, reviews, blog posts and discussion threads 320; the number of negative rankings that the user has received for his or her own ideas, comments, reviews, blog posts and discussion threads 325; a measure of the user's past performance in correctly betting on Prediction Market instruments 330; a measure of the user's past performance in investing and rating in ideas in the Innovation Market that exit successfully 335; or the number of ideas posted by the user that have a successful or unsuccessful exit 340.

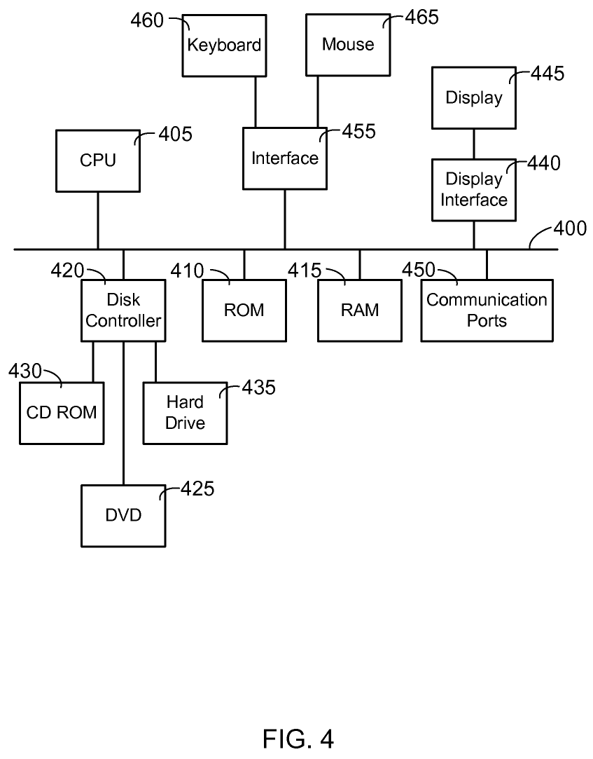

Any or all of the methods described herein may be embodied in computer-readable code that instructs processing device to implement the methods. FIG. 4 depicts a block diagram of an exemplary system that may be used to contain or implement program instructions according to an embodiment. FIG. 4 depicts a block diagram of an exemplary system that may be used to contain or implement program instructions according to an embodiment. Referring to FIG. 4, a bus 400 serves as the main information highway interconnecting the other illustrated components of the hardware. CPU 405 is the central processing device of the system, performing calculations and logic operations required to execute a program. Read only memory (ROM) 410 and random access memory (RAM) 415 constitute exemplary memory devices or storage media.

A disk controller 420 interfaces with one or more optional disk drives to the system bus 400. These disk drives may include, for example, external or internal disk, flash memory, USB or other drives 425, CD ROM drives 430 or hard drives 435. As indicated previously, these various disk drives and disk controllers are optional devices.

Program instructions may be stored in the ROM 410 and/or the RAM 415. Optionally, program instructions may be stored on a computer readable storage medium, such as a hard drive, a compact disk, a digital disk, a memory or any other tangible recording medium.

An optional display interface 440 may permit information from the bus 400 to be displayed on the display 445 in audio, graphic or alphanumeric format. Communication with external devices may occur using various communication ports 450.

In addition to the standard computer-type components, the hardware may also include a data input interface 455 which allows for receipt of data from input devices such as a keyboard 460 or other input device 465 such as a mouse, remote control, touch pad or screen, pointer and/or joystick

It will be appreciated that various of the above-disclosed and other features and functions, or alternatives thereof, may be desirably combined into many other different systems or applications. Various presently unforeseen or unanticipated alternatives, modifications, variations or improvements therein may be subsequently made by those skilled in the art which are also intended to be encompassed by the following claims.

What is claimed is:

1. A method of ranking user reputation in a multi-user network, comprising:
displaying, via a display interface to a plurality of registered users of a multi-user network, a plurality of concepts for discussion;
receiving, from a first registered user via a data interface, a discussion post and a ranking for a selected one of the displayed concepts;
receiving, from a plurality of other registered users, a plurality of responses to the first registered user's discussion post, wherein each response includes an indication of whether the response is positive or negative; and
determining, via a processing device, a reputation rank for the first registered user, wherein the reputation rank is determined based on:
a number of discussion posts received from that registered user, and
a number of positive responses received from the other registered users for the first registered user's discussion posts; and
displaying the reputation rank to the registered users via the display interface.

2. The method of claim 1, further comprising:
determining an indication of merit for the selected displayed concept, wherein the indication of merit is based at least in part on the reputation rank for each user who submitted a discussion post or ranking for the selected displayed concept.

3. The method of claim 2, wherein the indication of merit for the selected displayed concept is also based on at least:
a number of different registered users who have submitted comments for the selected displayed concept;
a user interest for the selected displayed concept.

4. The method of claim 1, wherein determining the reputation rank for the first registered user is also based on:
a number of positive rankings that have been received from other registered users for ideas previously submitted by the first registered user; and
a number of negative rankings that have been received from other registered users for ideas previously submitted by the first registered user.

5. The method of claim 1, wherein determining the reputation rank for the first registered user is also based on:
a number of friends that have connected to the first registered user as connected friends;
a number of positive rankings that the connected friends have submitted for the first registered user; and
a number of negative rankings that the connected friends have submitted for the first registered user.

6. The method of claim 1, wherein determining the reputation rank for the first registered user is also based on:
a number of ideas posted by the first registered user that have a successful exit; and
a number of ideas posted by the first registered user that have an unsuccessful exit.

7. The method of claim 1, wherein determining the reputation rank for the first registered user is also based on:
an amount of virtual money that the first registered user has invested in correct outcomes in a prediction market; and
an amount of virtual money that the first registered user has invested in incorrect outcomes in the prediction market.

8. The method of claim 1, further comprising:
receiving, from the first registered user, a first discussion concept;
receiving, from a plurality of other registered users, a plurality of comments to the first discussion concept, wherein each comment includes an indication of whether it is positive or negative; and
determining, via the processing device, an indication of merit from the first discussion concept; and
providing a reward to the first registered user, wherein an amount of the reward is based on the indication of merit for the first discussion concept and the reputation rank for the first registered user.

9. A computer-program product containing computer-readable code that instructs a computing device to perform a method of ranking user reputation in a multi-user network, the method comprising:
displaying, via a display interface to a plurality of registered users of a multi-user network, a plurality of concepts for discussion;
receiving, from a first registered user via a data interface, a discussion post and a ranking for a selected one of the displayed concepts;
receiving, from a plurality of other registered users, a plurality of responses to the first registered user's discussion post, wherein each response includes an indication of whether the response is positive or negative; and
determining, via a processing device, a reputation rank for the first registered user, wherein the determining is based on:
a number of discussion posts received from that registered user, and
a number of positive responses received from the other registered users for the first registered user's discussion posts; and
displaying the reputation rank to the registered users via the display interface.

10. The computer-program product of claim 9, further comprising instructions that instruct the computing device to include in the method:
determining an indication of merit for the selected displayed concept, wherein the indication of merit is based at least in part on the reputation rank for each user who submitted a discussion post or ranking for the selected displayed concept.

11. The computer program product of claim 10, wherein the code ensures that the indication of merit for the selected displayed concept is also based on at least:
a number of different registered users who have submitted comments for the selected displayed concept;
a user interest for the selected displayed concept.

12. The computer program product of claim 9, wherein the code ensures that the reputation rank for the first registered user is also based on:
a number of positive rankings that have been received from other registered users for ideas previously submitted by the first registered user; and
a number of negative rankings that have been received from other registered users for ideas previously submitted by the first registered user.

13. The computer program product of claim 9, wherein the code ensures that the reputation rank for the first registered user is also based on:
a number of friends that have connected to the first registered user as connected friends;
a number of positive rankings that the connected friends have submitted for the first registered user; and
a number of negative rankings that the connected friends have submitted for the first registered user.

14. The computer program product of claim 9, wherein the code ensures that the reputation rank for the first registered user is also based on:
a number of ideas posted by the first registered user that have a successful exit; and
a number of ideas posted by the first registered user that have an unsuccessful exit.

15. The computer program product of claim 9, wherein the code ensures that determining the reputation rank for the first registered user is also based on:
an amount of virtual money that the first registered user has invested in correct outcomes in a prediction market; and
an amount of virtual money that the first registered user has invested in incorrect outcomes in the prediction market.

16. The computer-program product of claim 9, further comprising instructions that instruct the computing device to include in the method:
receiving, from the first registered user, a first discussion concept;
receiving, from a plurality of other registered users, a plurality of comments to the first discussion concept, wherein each comment includes an indication of whether it is positive or negative; and
determining, via the processing device, an indication of merit from the first discussion concept; and
providing a reward to the first registered user, wherein an amount of the reward is based on the indication of merit for the first discussion concept and the reputation rank for the first registered user.
